(19) United States
(12) Patent Application Publication
(10) Pub. No.: US 2017/0251516 A1
(43) Pub. Date: Aug. 31, 2017

(54) CONNECTION CONTROL FOR MACHINE TYPE COMMUNICATION (MTC) DEVICES

(71) Applicant: INTEL IP CORPORATION, Santa Clara, CA (US)

(72) Inventors: SANGEETHA BANGOLAE, Houston, TX (US); ANA LUCIA PINHEIRO, Breinigsville, PA (US); MARTA MARTINEZ TARRADELL, Hillsboro, OR (US); UMESH PHUYAL, Beaverton, OR (US); PUNEET JAIN, Hillsboro, OR (US); MO-HAN FONG, Sunnyvale, CA (US)

(21) Appl. No.: 15/514,444

(22) PCT Filed: Jul. 30, 2015
(86) PCT No.: PCT/US15/42975

§ 371 Date: Mar. 24, 2017

Related U.S. Application Data
(60) Provisional application No. 62/067,659, filed on Oct. 23, 2014.

(51) Int. Cl. H04W 76/04; H04W 76/02

(52) U.S. Cl. CPC H04W 76/046; H04W 76/02; H04W 76/041

(57) ABSTRACT

Technology for switching a user equipment (UE) from a lightweight radio resource control (RRC) connection to a legacy RRC connection is disclosed. A radio base station can determine that the UE is to switch from the lightweight RRC connection with the radio base station to the legacy RRC connection with the radio base station, wherein the UE is configured to perform small data transmissions when the lightweight RRC connection is established for the UE. The radio base station can instruct the UE to perform a service request procedure in order for the UE to transition from the lightweight RRC connection to the legacy RRC connection. The radio base station can receive a service request message from the UE when the service request procedure is initiated at the UE, wherein the radio base station is configured to facilitate switching the UE from the lightweight RRC connection to the legacy RRC connection.

### BACKGROUND

Wireless mobile communication technology uses various standards and protocols to transmit data between a node (e.g., a transmission station) and a wireless device (e.g., a mobile device). Some wireless devices communicate using orthogonal frequency-division multiple access (OFDMA) in a downlink (DL) transmission and single carrier frequency division multiple access (SC-FDMA) in an uplink (UL) transmission. Standards and protocols that use orthogonal frequency-division multiplexing (OFDM) for signal transmission include the third generation partnership project (3GPP) long term evolution (LTE), the Institute of Electrical and Electronics Engineers (IEEE) 802.16 standard (e.g., 802.16e, 802.16m), which is commonly known to industry groups as WiMAX (Worldwide interoperability for Microwave Access), and the IEEE 802.11 standard, which is commonly known to industry groups as WiFi.

In 3GPP radio access network (RAN) LTE systems, the node can be a combination of Evolved Universal Terrestrial Radio Access Network (E-UTRAN) Node Bs (also commonly denoted as evolved Node Bs, enhanced Node Bs, eNodeBs, or eNBs) and Radio Network Controllers (RNCs), which communicates with the wireless device, known as a user equipment (UE). The downlink (DL) transmission can be a communication from the node (e.g., eNodeB) to the wireless device (e.g., UE), and the uplink (UL) transmission can be a communication from the wireless device to the node.

In homogeneous networks, the node, also called a macro node, can provide basic wireless coverage to wireless devices in a cell. The cell can be the area in which the wireless devices are operable to communicate with the macro node. Heterogeneous networks (HetNets) can be used to handle the increased traffic loads on the macro nodes due to increased usage and functionality of wireless devices. HetNets can include a layer of planned high power macro nodes (or macro-eNBs) overlaid with layers of lower power nodes (small-eNBs, micro-eNBs, pico-eNBs, femto-eNBs, or home eNBs [HeNBs]) that can be deployed in a less well planned or even entirely uncoordinated manner within the coverage area (cell) of a macro node. The lower power nodes (LPNs) can generally be referred to as “low power nodes”, small nodes, or small cells.

In LTE, data can be transmitted from the eNodeB to the UE via a physical downlink shared channel (PDSCH). A physical uplink control channel (PUCCH) can be used to acknowledge that data was received. Downlink and uplink channels or transmissions can use time-division duplexing (TDD) or frequency-division duplexing (FDD).

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure; and, wherein:

FIG. 1 illustrates signaling for switching an existing lightweight radio resource control (RRC) connection with an evolved node B (eNB) to a legacy RRC connection with the eNB for a user equipment (UE) in accordance with an example;

FIG. 2 illustrates signaling for initiating a legacy radio resource control (RRC) connection with an evolved node B (eNB) for a user equipment (UE) in accordance with an example;

FIG. 3 illustrates configuring a lightweight radio resource control (RRC) connection with a network on a per access point name (APN) basis for a user equipment (UE) in accordance with an example;

FIG. 4 illustrates configuring a lightweight radio resource control (RRC) connection with a network on a per access point name (APN) basis for a user equipment (UE) in accordance with an example;

FIG. 5 illustrates configuring a lightweight radio resource control (RRC) connection with a network on a per application basis for a user equipment (UE) in accordance with an example;

FIG. 6 depicts functionality of an apparatus of a network node in accordance with an example;

FIG. 7 depicts functionality of an apparatus of a network node in accordance with an example;

FIG. 8 depicts a flow chart of at least one non-transitory machine readable storage medium having instructions embodied thereon for switching a user equipment (UE) from a lightweight radio resource control (RRC) connection to a legacy RRC connection in accordance with an example; and

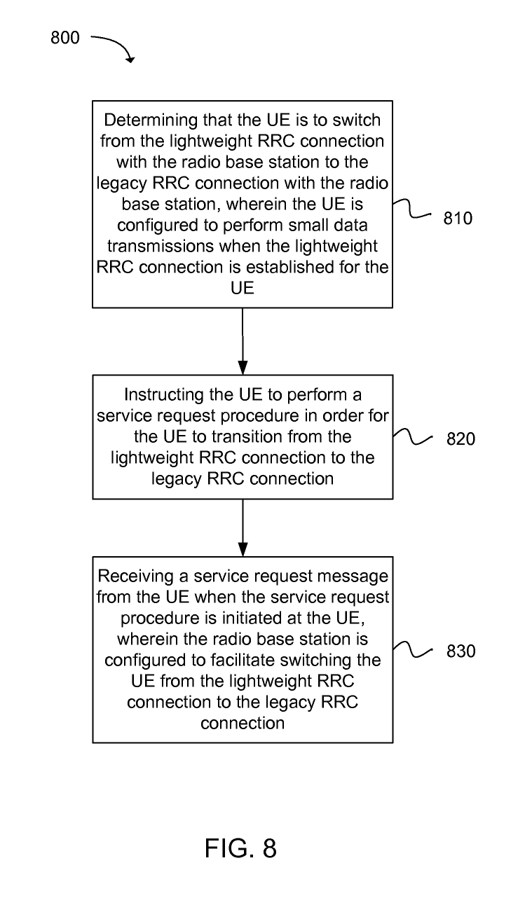

FIG. 9 illustrates a diagram of a wireless device (e.g., UE) in accordance with an example.

Reference will now be made to the exemplary embodiments illustrated, and specific language will be used herein to describe the same. It will nevertheless be understood that no limitation of the scope of the technology is thereby intended.

### DETAILED DESCRIPTION

Before the present technology is disclosed and described, it is to be understood that this technology is not limited to the particular structures, or materials disclosed herein, but is extended to equivalents thereof as would be recognized by those ordinarily skilled in the relevant arts. It should also be understood that terminology employed herein is used for the purpose of describing particular examples only and is not intended to be limiting. The same reference numerals in different drawings represent the same element. Numbers provided in flow charts and processes are provided for clarity in illustrating actions and operations and do not necessarily indicate a particular order or sequence.

### EXAMPLE EMBODIMENTS

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

With a wide range of potential applications, Machine Type Communication (MTC) or Machine to Machine (M2M) communication has gained large interest among equipment vendors, mobile network operators, and MTC specialist companies. As used herein, the terms M2M and MTC are used synonymously. MTC is a form of data communication among one or more entities that does not necessarily need human interaction. As used herein, the term “user equipment,” or UE, can refer to a mobile device, a smartphone device, an M2M device, or an MTC device, such as a smart meter, embedded cellular device or another type of device with 3G/4G/5G capability.

The UE can communicate through a Public Land Mobile Network (PLMN) with MTC servers and/or other MTC devices. In addition, the MTC device can communicate locally (e.g., wirelessly, through a personal area network (PAN), or hardwired) with other entities that provide the MTC device with data (e.g., a small data payload). Thereafter, the MTC device can process the data and then transmit the data to the MTC servers and/or other MTC devices. The MTC devices can include health monitoring devices, smart meters, sensors, etc.

MTC devices can transmit (i.e., send or receive) small amounts of data over a network. The small amount of data typically ranges from a few bits to kilobits of data. In one non-limiting example, small data payloads can typically be 1 to 128 bytes in length, but it should be understood that small data payloads can be larger in some instances. Generally, the small data is transmitted as a short data transfer in a single packet or burst. The network can be a wireless wide area network (WWAN) or wireless local area network (WLAN) based on a selected radio access network (RAN) technology. The WWAN can be configured to operate based on a cellular networking standard such as IEEE 802.16 standard, commonly referred to as WiMAX (worldwide interoperability for microwave access), and the third generation partnership project (3GPP). Releases of the IEEE 802.16 standard include the IEEE 802.16e-2005, 802.16-2009, and 802.16m-2011. Releases of the 3GPP standard include the 3GPP LTE, Release 8 in the fourth quarter of 2008, 3GPP LTE Advanced Release 10 in the first quarter of 2011, and 3GPP LTE Release 11 in the third quarter of 2012.

The MTC applications that are executed on the MTC devices can be related to a variety of areas, such as security (e.g., surveillance systems, driver security), tracking and tracing (e.g., asset tracking, navigation, traffic information, road tolling), payment (e.g., vending machines, gaming machines), health (e.g., monitoring vital signs, supporting the elderly or handicapped), remote maintenance/control (e.g., sensors, lighting, vehicle diagnostics), metering (e.g., power, gas, water, heating), and/or consumer devices (e.g., digital cameras).

Based on the wide array of potential M2M and Internet of Things (IoT) applications and devices, billions of applications and/or devices can be performing small data transfer in the future. There can be a large number of short-lived connections between the devices and the network in order to perform the small data transfers, thereby causing a large amount of signaling overhead in the 3GPP system. The usage of signaling is significantly high due to the advent of diverse data applications (e.g., background applications) that go from idle mode to connected mode, send a small amount of data (e.g., a keep-alive message or a status update) while in connected mode, and then go back to idle mode to save power. These periodic idle-to-connected mode transitions can use an undue amount of signaling (e.g., radio resources) over the control plane. The technology described herein provides a scalable solution to reduce the wastage of radio resources in signaling overhead due to small data transfer.

Lightweight radio resource control (RRC) connection mechanisms minimize signaling overhead while allowing for connectionless data transmissions. In other words, lightweight RRC connection mechanisms (or connectionless mechanisms) do not involve the full-blown establishment of a legacy RRC connection, but rather involves the UE performing a reduced number of actions to establish a “lightweight” RRC connection with the network in order to send small data. These mechanisms can be optimized for small and infrequent data transmissions. The UE is generally not allowed to send non-small data (i.e., data having a size that is above a defined threshold) when the lightweight RRC connection is established at the UE.

There is some concern that the UE can misuse the lightweight RRC connection mechanism, and use the lightweight RRC connection mechanism even when the UE has large amounts of data or frequent data to transmit. Moreover, the lightweight RRC connection can be less robust as compared to the legacy RRC connection since a reduced amount of configuration information is being exchanged between the UE and the network, and therefore, the lightweight RRC connection can only be suitable for certain applications or functionality that involve small data. Therefore, the technology described herein provides mechanisms that prevent the UE from misusing the lightweight RRC connection mechanism and allows the network to have increased control over which connection mechanism the UE will use (i.e., lightweight RRC connection or legacy RRC connection). By the network performing RRC connection control of MTC and other mobile data applications, the signaling when the UE transitions from idle to connected mode to send/receive data can be reduced.

Lightweight RRC connection mechanisms are further described in 3GPP Technical Report (TR) 37.869 Release 12, “Study on Enhancements to Machine-Type Communications (MTC) and other Mobile Data Applications; Radio Access Network (RAN) aspects” and 3GPP TR 23.887 Release 12, “Study on Machine-Type Communications (MTC) and other Mobile Data Applications Communications Enhancements.”

3GPP TR 37.869 and 3GPP TR 23.887 discuss S1-MME connectionless approaches (or lightweight connection approaches) in order to achieve signaling overhead reduction. In order to reduce the amount of signaling caused by idle-connected mode transitions, solutions can be defined where small amounts of data can be transferred while the UE has no non-access stratum (NAS) signaling connection. Examples of S1-MME connectionless approaches include a small data fast path solution, a connectionless data transmission solution, and a random access channel (RACH)-based small data transmission solution.

The S1-MME connectionless approaches, or lightweight connection approaches, can reduce the number of bytes transmitted in uplink and/or downlink at the UE in order to send the small data. For example, the signaling overhead for the small data fast path solution can be 114 bytes in DL and 48 bytes in UL, or 73 bytes in DL and 36 bytes in UL if no RRC connection reconfiguration is performed. In other words, when the UE is in idle mode and has small data to send, the UE can perform signaling with an overhead of 114 bytes in DL and 48 bytes in UL in order to wake up from idle mode and send the small data. In addition, the signaling overhead for the connectionless data transmission solution can be 114 bytes in DL and 48 bytes in UL, or 61 bytes in DL and 36 bytes in UL if no RRC connection reconfiguration is performed. The signaling overhead for the RACH-based small data transmission solution can be 20 bytes in DL and 17-19 bytes in UL.

In contrast, the signaling overhead when the UE transitions from idle mode to the legacy RRC connected mode using the service request procedure is greater than the signaling overhead for the S1-MME connectionless approaches. The signaling overhead for establishing the legacy RRC connection can be 136 bytes in DL and 59 bytes in UL, which is significantly more than the number of DL and UL bytes in signaling overhead for the S1-MME connectionless approaches described above.

In one configuration, when the UE attaches to the cellular network, the UE performs a full attach procedure that involves the communication of multiple RRC and core network related messages. The attach procedure is described in 3GPP TS 23.401 Release 12, “GPRS enhancements for E-UTRAN access” and 3GPP TS 36.331 Release 12, “Radio Resource Control Specification.” The UE is in connected mode after performing the attachment procedure. The UE can be configured to send or receive data after attaching to the cellular network.

In order to save power when the UE is in connected mode, the network can enter the UE into idle mode after a defined period of inactivity time. In other words, if the UE does not send or receive any data for a defined period of time (i.e., the UE is inactive during this time), then the UE can enter into idle mode. The defined period of inactivity time can be set by the network (e.g., the eNB). While the UE is in idle mode, if the UE has uplink data to send or receives a paging message due to pending downlink data, the UE can perform a service request procedure. The service request procedure can allow the UE to reconnect with the cellular network in order to send or receive data. In other words, if the UE performs the service request procedure when in idle mode, the UE can send the uplink data or receive the pending downlink data. The service request procedure can involve a series of RRC and core network messages between the UE and the network. This signaling can allow the eNB to obtain UE context information, and set up the up the RRC connection for the UE. The signaling overhead for performing the service request procedure can be hundreds of bytes, which can be often be greater than the amount of data to be sent.

As a non-limiting example with respect to traditional solutions, a UE can enter into idle mode from connected mode after a defined period of inactivity. At some later point, the UE can have small data to send or receive, and therefore, the UE can perform the service request procedure in order to enter into connected mode and attach to the cellular network. The UE can use approximately 200 bytes to perform the service request procedure and enter into connected mode. After connected mode is established for the UE, the UE can send the small data, which can be approximately 20 bytes. The UE can send the small data, and after another period of inactivity, the UE can go back into idle mode. Therefore, the amount of signaling to send the small data can be far greater in size than the small data itself (i.e., 200 bytes of signaling overhead to send 20 bytes of small data).

When the UE transitions into connected mode using the lightweight RRC connection (as opposed to the legacy RRC connection), the UE can use a reduced number of bytes to send or receive the small data. The UE can wake up from idle mode and send or receive data using pre-established UE contexts, thereby reducing the amount of signaling. Lightweight RRC connection establishment can also be referred to as fast path solutions or S1-MME connectionless solutions. In order to take advantage of the fast path, S1-MME connectionless or lightweight connection solutions that allow the UE to quickly send data without using full-blown legacy RRC connection establishment signaling, the data should be classified as “small data” or “short data” and not be sent very frequently. In other words, the size of the data should be within a defined threshold and the frequency of the data transmissions or receptions should be within a defined threshold. Due to the reduction in signaling, the lightweight RRC connection mechanisms can aid in reducing latency. However, the lightweight RRC connection mechanisms should not be abused and used for sending non-small data and/or frequent data transfer.

The avoidance of such abuse can be desirable because the eNB can have predefined resources to support small data in some cases, e.g., the lightweight connection may be supported only for dedicated MTC nodes, in which case supporting high data rate applications using the same connection may be unreasonable. In addition, the lightweight connection can only have a certain type of bearer configuration supported that may not be suitable for other traffic, so switching to a legacy connection path and establishing new EPS bearers may be necessary. Therefore, when the UE has non-small data or frequent data to transfer, the UE can use the legacy RRC connection setup procedure, as well as the corresponding default bearer or dedicated bearer as applicable.

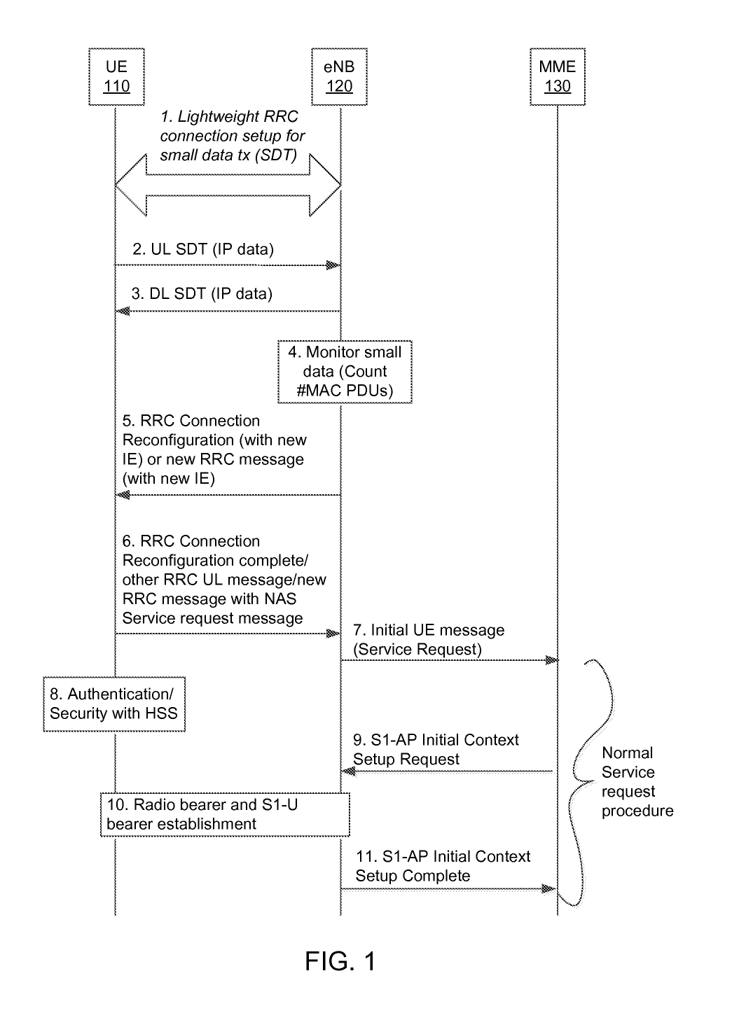

FIG. 1 illustrates exemplary signaling for switching an existing lightweight radio resource control (RRC) connection with an evolved node B (eNB) 120 to a legacy RRC connection with the eNB 120 for a user equipment (UE) 110. In other words, the UE 110 can transition from the lightweight RRC connection to the legacy RRC connection using the exemplary signaling shown in FIG. 1. By allowing the UE to transition from the lightweight RRC connection to the legacy RRC connection, possible overuse of the lightweight RRC connection procedure can be reduced. For devices that are dedicated to send only M2M or MTC data, then the potential overuse of the lightweight RRC connection is minimal. However, for devices that are configured to send both types of data (I.e., small data and non-small data, such as video), network-triggered and/or UE-triggered mechanisms for implementing the lightweight RRC connection solution in order to reduce signaling for small data.

As shown in FIG. 1, in action 1, a lightweight RRC connection setup can be performed between the UE 110 and eNB 120. The lightweight RRC connection setup can enable small data transmissions (SDT) between the UE 110 and eNB 120. In action 2, the UE 110 can perform uplink small data transmissions with the eNB 120. In other words, the UE 110 can send uplink Internet Protocol (IP) data to the eNB 120 using the lightweight RRC connection. In action 3, the UE 110 can receive downlink small data transmissions from the eNB 120. In other words, the UE 110 can receive downlink IP data from the eNB 120 using the lightweight RRC connection.

When the UE 110 is sending or receiving data via the lightweight RRC connection, the eNB 120 can trigger a transition from the lightweight RRC connection to the legacy RRC connection. In other words, the eNB 120 can trigger the UE 110 to switch from a lightweight RRC connected mode to a legacy RRC connected mode. As non-limiting examples, the eNB 120 can trigger the UE 110 to switch from the lightweight RRC connected mode to the legacy RRC connected mode when: the data transmission is no longer small (i.e., when the size of the data transmission has exceeded a defined threshold), a data connection for performing the data transmission is longer in time than a defined threshold, security is to be reestablished for the data transmission due to an expiry of a pre-established context, etc. In another example, the eNB 120 can trigger the UE 110 to switch from the lightweight RRC connected mode to the legacy RRC connected mode when certain applications or groups/categories of applications are launched on the UE 110. The data associated with these applications can be greater than the defined threshold associated with small data. These applications can be related to Multimedia Subsystem (IMS) video, voice, etc. In yet another example, the eNB 120 can trigger the UE 110 to switch from the lightweight RRC connected mode to the legacy RRC connected mode when the UE needs a certain level of quality assurance. In other words, if the UE 110 is executing an application that needs a quality of service (QoS) guarantee, then the UE 110 can be switched to the legacy RRC connection. The legacy RRC connection can guarantee the QoS for the UE 110, while the lightweight RRC connection may not be able to guarantee the QoS for the UE 110.

In action 4, the eNB 120 can monitor the small data transmissions for the UE 110. In one example, the eNB 120 can monitor the small data transmissions at the UE by counting a number of media access control (MAC) packet data units (PDUs) that are transmitted from the UE 110. By counting the number of MAC PDUs, the eNB 120 can determine whether or not the UE 110 is transmitting small data.

In action 5, the eNB 120 can trigger the UE 110 to switch from the lightweight RRC connected mode to the legacy RRC connected mode based on monitoring of the small data transmissions at the UE 110. The lightweight RRC connection can be associated with a predefined MAC PDU count. If the predefined MAC PDU count is exceeded at the UE 110 (i.e., the amount of data sent by the UE 110 is not small data), then the eNB 120 can trigger the switch to the legacy RRC connected mode. As a result, potential misuse of the lightweight RRC connection for sending non-small data can be avoided.

In particular, with respect to action 5, the eNB 120 can send a legacy RRC message in downlink to the UE 110 to trigger the switch to the legacy RRC connected mode. The legacy RRC message can include an RRC connection setup message or an RRC connection reconfiguration message. The legacy RRC message can include a novel information element (IE) to indicate the switch from the lightweight RRC connected mode to the legacy RRC connection mode. Examples IEs can include a connection control information IE or a connection switching control information IE, which can include additional IEs to indicate the switch to the legacy RRC connected mode. The legacy RRC message can trigger the establishment of a traditional end-to-end connection using signaling radio bearer 1 (SRB1) or SRB0, based on which signaling bearer is set up. By sending the legacy RRC message with the novel IE when the UE is currently using the lightweight RRC connection mechanism, the eNB 120 can indicate that the UE 110 is to establish the legacy RRC connection and the lightweight RRC connection is no longer allowed to be used.

In an alternative example, a novel RRC message can be defined to trigger the switch to the legacy RRC connected mode. The novel RRC message can include an RRC connection control message or an RRC connection change message. These novel RRC messages can include the connection control information IE or the connection switching control information IE, which can indicate to the UE 110 to transition the lightweight RRC connection to the legacy RRC connection. Therefore, the eNB 120 can monitor the data transmissions from the UE 110, and if the UE 110 is no longer sending or receiving small data, the eNB 120 can send a command message to the UE 110 to redirect the UE 110 to establish the legacy RRC connection and continue with the corresponding procedures in the back-end (e.g., the service request procedure).

In one example, when the UE 110 is switched to the legacy RRC connection, the eNB 120 and a mobility management entity (MME) 130 can exchange additional messages to obtain the UE context. Furthermore, the additional messages can function to inform the MME 130 that the UE 110 is in Evolved Packet System (EPS) Connection Management (ECM) connected mode and no longer in ECM idle mode. The additional messages can be exchanged when, during the lightweight connection/S1-MME connectionless process, the UE 110 was in ECM idle mode and in lighted RRC connection mode.

In action 6, the UE 110 can send an RRC message with a non-access stratum (NAS) service request message. The UE 110 can send the RRC message with the NAS service request message in response to receiving the legacy RRC message (or novel RRC message) from the eNB 120 that triggered the switch to the legacy RRC connection. The NAS service request message can be part of a service request procedure, which can switch the UE 110 from the lightweight RRC connected mode to the legacy RRC connected mode.

In an alternative configuration, the UE 110 can monitor its own small data transmissions, as opposed to the eNB 120 monitoring the UE's small data transmissions. For example, the UE 110 can count the number of MAC PDUs that are transmitted from the UE 110. If the number of MAC PDUs is above a defined threshold, which can indicate that the data transmitted from the UE 110 is no longer small data, then the UE 110 can automatically send the NAS service request message to the eNB 120. In this configuration, the eNB 120 does not send the legacy RRC message to the UE 110 in order to trigger the UE's switch to the legacy RRC connected mode.

In actions 7 through 11, the service request procedure can be performed in order to switch the UE 110 to the legacy RRC connected mode. Since the data transmitted from the UE 110 is no longer small data, the UE 110 is to switch to the legacy RRC connected mode in order to perform subsequent data transmissions. In action 7, the eNB 120 can send an initial UE message with a service request to the MME 130. In action 8, the UE 110 can perform an authentication and security procedure with a home subscriber server (HSS). In action 9, the MME 130 can send an S1-AP initial context setup request message to the eNB 120. The S1-AP initial context setup request message can include radio capabilities, configuration information, bearer information, tunneling information, etc. for establishing the legacy RRC connection. In action 10, the UE 110 and the eNB 120 can perform a radio bearer and S1-U bearer establishment procedure. In action 11, the eNB 120 can send an S1-AP initial context setup complete message to the MME 130. At this point, the UE 110 can be in the legacy RRC connected mode and is configured to send the non-small data via the legacy RRC connection. Although the actions involved in the service request procedure can be cumbersome, the amount of signaling required is acceptable when the RRC connection is long-lived.

In one configuration, a serving gateway (SGW) can monitor the small data transmissions for the UE 110, as opposed to the eNB 120. The SGW can send a general packet radio service (GPRS) tunneling protocol (GTP)-C message to the eNB 120 indicating that a level of small data maintained in a buffer at the SGW for the UE 110 is greater than a defined threshold. Based on the GTP-C message, the eNB 120 can trigger the UE 110 to switch from the lightweight RRC connection to the legacy RRC connection.

In FIG. 1, although the messages are explained with respect to the LTE/LTE-advanced specification, the flow/concept can be applied to other advanced radio access technology as well.

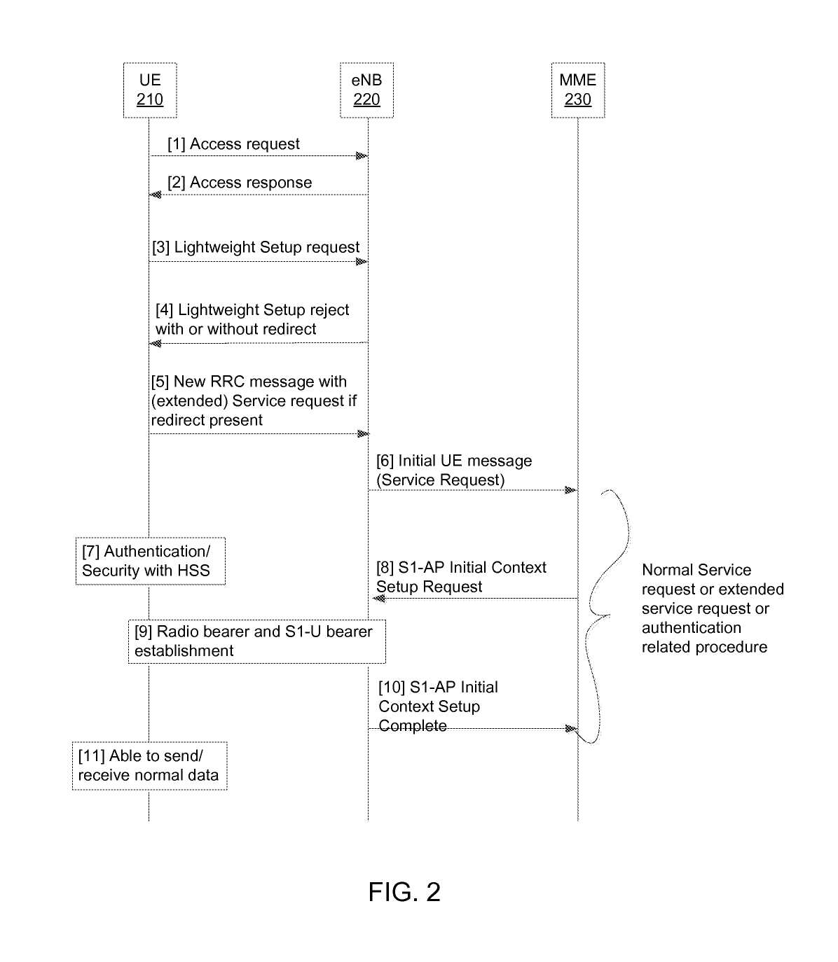

FIG. 2 illustrates exemplary signaling for initiating a legacy radio resource control (RRC) connection with an evolved node B (eNB) 220 for a user equipment (UE) 210. The legacy RRC connection can be initiated during a lightweight RRC mode establishment procedure. As shown in action 1, the UE 210 can send an access request message to the eNB 220, and in response, in action 2, the eNB 220 can send an access response message to the UE 210. In action 3, the UE 210 can send a lightweight setup request message to the eNB 220. The UE 210 can send the lightweight setup request message in order to initiate establishment of a lightweight RRC connection with the eNB 220. In one example, the UE 210 can initiate the establishment of the lightweight RRC connection when the UE 210 has data (e.g., small data) to send to a recipient. In one example, the UE 210 can wake up from idle mode and initiate the establishment of the lightweight RRC connection in order to send small data. In other words, the UE 210 may not have an RRC connection with the eNB 220 prior to sending the lightweight setup request message.

The eNB 220 can determine whether to permit the lightweight RRC connection to be established for the UE 210. Alternatively, the eNB 220 can determine whether to reject the lightweight connection setup request received from the UE 210, thereby preventing the UE 210 from establishing the lightweight RRC connection. It may be undesirable for the eNB 220 to establish of the lightweight RRC connection, and then establish the legacy RRC connection for the UE 210 at a later time, as performing these two separate procedures can result in an increased amount of signaling as opposed to reducing the amount of signaling. Therefore, upon receiving the lightweight connection setup request from the UE 210, the eNB 220 can determine whether to permit the establishment of the lightweight RRC connection, or simply redirect the UE 210 to establish the legacy RRC connection and not establish the lightweight RRC connection.

In one example, when the lightweight setup request message is received at the eNB 220, the eNB 220 may not have the necessary context (e.g., security context) or stored contexts have expired in accordance with a timer. In this case, the eNB 220 may not wish to handle a lightweight RRC mode for the UE 210. Therefore, in action 4, the eNB 220 can send a lightweight connection setup reject message to the UE 210. The lightweight connection setup reject message can include an instruction for the UE 210 to establish the legacy RRC connection. In other words, the eNB 220 can reject the UE's request to establish the lightweight RRC connection, and instead, redirect the UE 210 to establish the legacy RRC connection using a service request procedure or an extended service request procedure. The eNB 220 can redirect the UE 210 to establish the legacy RRC connection using the lightweight connection setup message or an existing RRC message.

In one configuration, the eNB 220 can determine whether or not to permit the lightweight RRC connection for the UE 210 based on historical data transmissions by the UE 210. The eNB 220 can monitor the UE's previous activity level in uplink and determine whether to permit the UE 210 to establish the lightweight RRC connection. In other words, the eNB 220 can decide whether the UE 210 is allowed to use the lightweight RRC connection mechanism for small data transmissions in the future based on the UE's history of data transmission. In one example, core network assistance information received at the eNB 220 from a mobility management entity (MME) 230 can provide the eNB 220 with the UE's historical traffic. In addition, whether or not the UE 210 is allowed to use the lightweight RRC connection mechanism can be determined based on predefined criteria with respect to service, UE class or priority. Alternatively, the criteria can be dynamically adjusted based on channel or network conditions. Based on the historical data transmissions by the UE 210, the eNB 220 can determine whether or not to permit the lightweight RRC connection for the UE 210.

In one example, the eNB 220 can allow the UE 210 to use the lightweight RRC connection mechanism after receiving a first lightweight connection setup request from the UE 210. During this first lightweight connection session, if the UE 210 sends small data in uplink that is within a defined threshold maintained by the eNB 220, then the eNB 220 permits a second request from the UE 210 for establishing the lightweight RRC connection (i.e., a subsequent lightweight connection session). On the other hand, if the UE 210 sends small data in uplink that is above the defined threshold during the first lightweight connection session, based on the UE's history, the eNB 220 may not permit the second request for establishing the subsequent lightweight connection session within a certain period of time.

Based on the various mechanisms described above, the UE 210 can receive the lightweight connection setup reject message that includes the instruction to establish the legacy RRC connection, as indicated in action 4, and in action 5, the UE 210 can send an RRC message in uplink that includes a service request message to the eNB 220. In other words, if the lightweight connection setup reject message includes the instruction to establish the legacy RRC connection, the UE 210 can initiate the service request procedure for establishing the legacy RRC connection.

As an alternative, the UE 210 can receive the lightweight connection setup reject message from the eNB 220, wherein the lightweight connection setup reject message does not include the instruction to establish the legacy RRC connection. In this case, the UE 210 may not send the RRC message that includes the service request message, as indicated in action 5. Rather, the UE 210 can initiate a random access channel (RACH) procedure, and then send a legacy RRC connection request message to the eNB 220. The UE 210 may initiate the RACH procedure and then send the legacy RRC connection request message if the network is heavily congested (i.e., network congestion is above a defined threshold).

In action 5, the service request message sent by the UE 210 in order to initiate the service request procedure can be a legacy service request non-access stratum (NAS) message. The legacy service request NAS message can be included in the RRC message, such as an RRC connection setup complete message or in a related RRC message. The related RRC message can for an RRC uplink (UL) information transfer or for UE assistance information. The RRC message can be for initiating a full UE context download from the MME 230, end-to-end EPS bearer establishment, etc. In one example, the RRC message can be defined as a UE connection control message or a similar message.

In action 6, the eNB 220 can send an initial UE message with a service request to the MME 230. In action 7, the UE 210 can perform an authentication and security procedure with a home subscriber server (HSS). In action 8, the MME 230 can send an S1-AP initial context setup request message to the eNB 220. In action 9, the UE 210 and the eNB 220 can perform a radio bearer and S1-U bearer establishment procedure. In action 10, the eNB 220 can send an S1-AP initial context setup complete message to the MME 230. Actions 6 to 10 can be part of a legacy service request procedure or an extended service request procedure or an authentication-related procedure. At action 11, the UE 210 can be configured to send or receive data (e.g., non-small data) using the legacy RRC connection with the eNB 220.

In FIG. 2, although the messages are explained with respect to the LTE/LTE-advanced specification, the flow/concept can be applied to other advanced radio access technology as well.

In an alternative configuration, the UE 210 can trigger the service request procedure. In other words, the UE 210 may not send the lightweight setup request message to the eNB 220. Rather, the UE 210 can determine to establish the legacy RRC connection, and then send the RRC message that includes a service request message to the eNB 220. In this configuration, the network can permit UE-triggered mechanisms, which allow the UE 210 to initiate the service request procedure without explicit instruction from the eNB 220. For example, the network can permit UE-triggered mechanisms during lightly loaded network conditions (i.e., network traffic is below a defined threshold). Whether the service request procedure is initiated by the UE 210 or the eNB 220, an existing traffic flow through a pre-established bearer can be seamlessly transferred to a new bearer during the service request procedure.

In one configuration, when the lightweight RRC connection is already established for the UE, the network can send to the UE an instruction to switch from the lightweight RRC connection to a legacy RRC connection (i.e., initiate a service request procedure to establish the legacy RRC connection) using a media access control (MAC) control element (CE). The network can piggyback the instruction to switch from the lightweight RRC connection to the legacy RRC connection with a downlink (DL) data message. In other words, the network can send both the switching instruction and the DL data message at the same time. The network may not send the MAC CE in response to receiving a request from the UE. The network can send the instruction to switch from the lightweight RRC connection to the legacy RRC connection using the MAC CE as an alternative to using an RRC message.

In an alternative example, when the UE is in idle mode (i.e., no lightweight RRC connection is currently established for the UE), the network can piggyback an instruction to establish a legacy RRC connection with a downlink (DL) data message using a MAC CE.

The MAC CE used to convey the instruction to the UE for switching to the legacy RRC connection can be defined by extending the functionality of an existing MAC CE (e.g., an activation or deactivation MAC CE) with a reserved bit. The reserved bit can be used to indicate the command of establishing the legacy RRC connection or switching from the lightweight RRC connection to the legacy RRC connection. Alternatively, the MAC CE used to convey the instruction to the UE can be defined using a novel MAC CE, which can include a novel MAC CE header and a MAC CE payload. In another example, the novel MAC CE may be defined to have no payload, and instead only contain a MAC CE header with the relevant information needed by the UE for transitioning to the legacy RRC connection. In addition, a novel logical channel identifier (LCID) can be defined for the novel MAC CE.

In one example, the MAC CE can include various types of information to aid the UE when transitioning to the legacy RRC connection. For example, the MAC CE can include an indication that the UE has to stop using the lightweight RRC connection and start switching to the legacy RRC connection. As a result, the UE can request the transition by triggering a legacy RRC connection establishment procedure. Alternatively, the network can start the establishment of the legacy RRC connection (and the corresponding bearers) by sending an indication to switch to the legacy RRC connection within an RRC message, as previously described. In addition, the information included in the MAC CE to aid the UE in transitioning to the legacy RRC connection can include a new bearer identifier (ID), updated radio configuration information. In this case, the UE may not have to trigger the legacy RRC connection establishment procedure, as the network is already establishing the legacy RRC connection and sending the relevant information to the UE.

In one example, the UE can trigger the transition to the legacy RRC connection, as opposed to the network. The UE can indicate a request to transition to the legacy RRC connection using an existing MAC CE or a novel MAC CE. One existing MAC CE that can be reused for sending the request to transition to the legacy RRC connection can be a buffer status report (BSR). The functionality of the BSR can be extended to include a reserved bit that can indicate the request for transitioning to the legacy RRC connection.

In previous solutions, an RRC connection request sent from the UE to the network can include a small data indicator, which can enable a reduction of signaling for small data transfer. The RRC connection request can be a first RRC message sent by the UE to the network when initiating a lightweight RRC connection establishment procedure. Based on the small data indicator, the network can facilitate the establishment of the lightweight RRC connection. By using a small data filter mechanism to determine whether the data to be transmitted from the UE is indeed small data, the lightweight RRC connection can be established for signaling and power reduction. However, relying on the UE's small data filtering or the UE's capability in determining that the upcoming uplink (DL) data transfer will be small data, and then sending an RRC connection request with such an indicator, can be unreliable. Therefore, it would be beneficial for the network to perform monitoring of the UE's behavior, or to define a more reliable and scalable technique for a reduced signaling mechanism over the traditional RRC connection setup.

In one configuration, initial data activity timer based mechanisms can be used when determining to switch a UE from a lightweight RRC connection to a legacy RRC connection. The eNB can initially permit the UE to use the lightweight RRC connection when, for example, uplink data from the UE does not need dedicated bearer establishment. As an example, dedicated bearer establishment can be required for file transfer protocol (FTP) or voice/video services. The UE can be permitted to use the lightweight RRC connection or connectionless service for a specific period of time, as defined by a timer. The timer can be referred to as a small data activity timer or an initial activity timer. The timer can be maintained at the eNB. In addition, the timer may not limit the number of applications that are using the lightweight RRC connection to send small data. In one example, the timer can be set to between 50 milliseconds (ms) and 500 ms, depending on the network load and an expected duration for data transmission. In other words, the UE is permitted to send presumably small data for a duration of 50 ms to 500 ms using the lightweight RRC connection. If the eNB detects that the UE is continuing to request for UL resources after the timer expires, then the eNB can determine to switch the UE from the lightweight RRC connection to the legacy RRC connection. If the UE is requesting for UL resources after the timer expires, then the data being transmitted by the UE is presumably not small data. Since using the lightweight RRC connection for sending non-small data can be a misuse of the lightweight RRC connection, the eNB can initiate the service request procedure for switching the UE to the legacy RRC connection. The legacy RRC connection utilizes a default/dedicated bearer, whereas the lightweight RRC connection (and other connectionless services) use a pre-established bearer, pre-configured/pre-established security context, etc. Based on the initial data activity timer based mechanism, the UE can switch to the legacy RRC connection in order to send uplink data that does not comply with the definition of small data.

In one configuration, the timer for uplink data (e.g., the small data activity timer or the initial activity timer) can be maintained at the UE. In one example, the timer can be set to between 50 ms and 500 ms. The UE, as opposed to the network, can detect when UL resources are continued to be requested from the UE after the timer expires. In this case, the UE can initiate a service request procedure to switch from the lightweight RRC connection to the legacy RRC connection. Thus, the UE can indicate via RRC messages to transfer the lightweight RRC connection to the legacy RRC connection (e.g., to avoid barring) when the timer expires.

In one configuration, the timer (e.g., the small data activity timer or the initial activity timer) can be maintained at a serving gateway (SGW) or an MME. The timer can be for accumulated downlink data in a SGW buffer for the UE. The SGW can buffer the downlink data when the UE is in idle mode or unavailable. If the SGW buffer is within a certain subscription, service or priority based threshold, then the SGW can maintain the timer during the transfer of the downlink data when the lightweight RRC connection is established for the UE. The SGW can indicate to the eNB, either directly or through the MME, when the timer has expired. For example, the timer can be set to between 50 ms and 500 ms. If the downlink data flow for the UE continues after expiration of the timer (i.e., downlink data for the UE continues to be stored at the SGW buffer after the timer expires), then it can be presumed that the downlink data is not small data. Therefore, the eNB can determine to switch the UE from the lightweight RRC connection to the legacy RRC connection.

In one example, the timer for downlink data (e.g., the small data activity timer or the initial activity timer) can be maintained at the UE. The UE can detect when downlink data is continuing to flow to the SGW buffer, even after expiry of the timer. In this case, the UE can initiate a service request procedure to switch from the lightweight RRC connection to the legacy RRC connection.

In one configuration, the network can adjust UE idle context based on a history of data transmissions by the UE. It is possible that the UE can initially report a reduced buffer status report (BSR) to gain access to the lightweight RRC connection. However, to discourage UEs from repeatedly reporting reduced BSRs to gain access to the lightweight RRC connection, the eNB can adjust the UE's context information during idle mode with a status check bit. The UE's context information can be adjusted with the status check bit depending on whether or not the UE is allowed to the lightweight RRC connection for the next session. In other words, the status check bit can indicate whether the UE is permitted for connectionless access. In addition, the eNB can add a timer to monitor the UE for a defined period of time before permitting the lightweight RRC connection to be established. If the UE has non-small data to send, then the eNB can redirect the UE to establish the legacy RRC connection.

In one configuration, the UE can determine whether to switch from the lightweight RRC connection to the legacy RRC connection. The UE can determine to switch to the legacy RRC connection based on channel conditions and/or an expected time for transmitting the uplink (UL) data. In this configuration, the UE can determine to switch to the legacy RRC connection, as opposed to the network determining that the UE is to switch to the legacy RRC connection. If the expected time for the transmission of data in the UE's uplink buffer is below a certain threshold, then the UL data is considered to be small data and the UE is permitted to use lightweight RRC connection mechanisms for sending the small data. The threshold for the expected time of data transmission for one exchange can be predefined based on service, UE class, priority and/or subscription information. Alternatively, the threshold for the expected time of data transmission for one exchange can be dynamically adjusted based on channel conditions and/or network conditions. As a result, the UE may not be allowed to use lightweight RRC connection mechanisms for data transmissions that are predicted to take a prolonged period of time when the UE has poor channel conditions and/or when the network is congested. In addition, the threshold for determining whether the UL data at the UE is indeed “small data” can be dynamically adjusted based on network conditions and/or channel conditions.

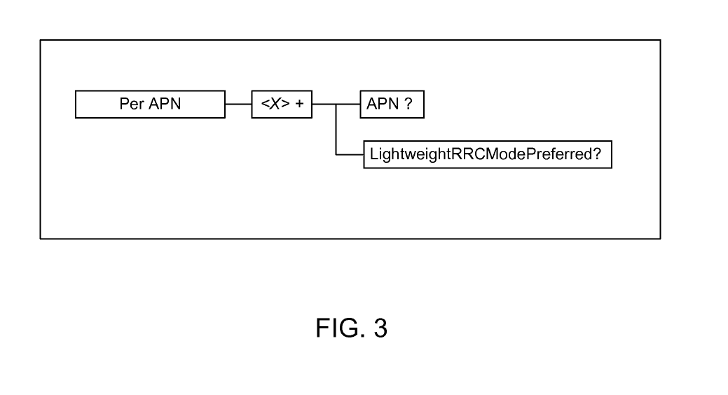

FIG. 3 illustrates an exemplary lightweight radio resource control (RRC) connection configuration for a user equipment (UE) on a per access point name (APN) basis. The network can notify the UE on which applications or services can use the lightweight RRC connection. In other words, the network can pre-configure the UE to use these applications or services using the lightweight RRC connection. The network can configure the UE using Open Mobile Alliance-Device Management (OMA-DM) functionality by sending information about the applications or services in the OMA-Management Object (OMA-MO) to the UE. In the example shown in FIG. 3, novel management objects can be created to configure the UE to use these applications or services using the lightweight RRC connection.

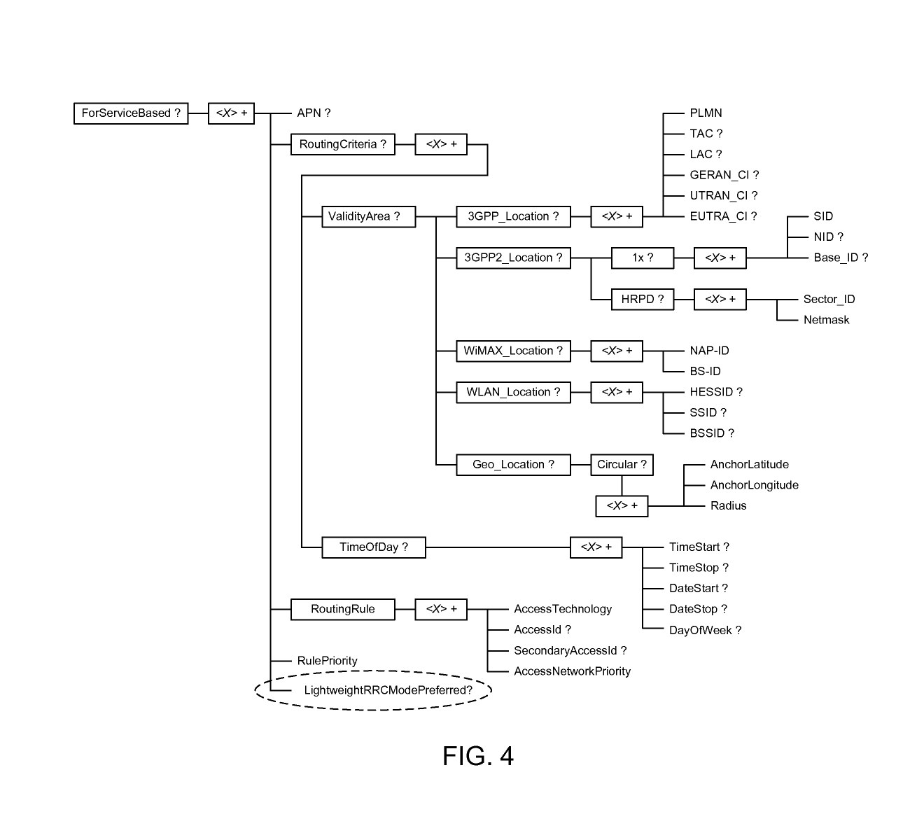

FIG. 4 illustrates an exemplary lightweight radio resource control (RRC) connection configuration for a user equipment (UE) on a per access point name (APN) basis. The network can notify the UE on which applications or services can use the lightweight RRC connection. In other words, the network can pre-configure the UE to use these applications or services using the lightweight RRC connection. In the example shown in FIG. 4, the information can be part of the Access Network Discovery and Selection Function (ANDSF) management objects (MO) to inform the UE which applications or services can use the lightweight RRC connection.

With respect to FIGS. 3 and 4, the lightweight RRC connection configuration for the UE on the per APN basis can include a lightweight RRC mode preferred (LightweightRRCModePreferred) value. The lightweight RRC mode preferred value can indicate whether a connection to a specific APN can be established via lightweight RRC connection. The lightweight RRC mode preferred can include a “0” or a “1”, wherein a “0” indicates that the connection to the APN cannot be established via the lightweight RRC connection, and a “1” indicates that the connection to the APN can be established via the lightweight RRC connection. As an example, if a device (e.g., a smart meter) always uses a particular APN to send small data, then the lightweight RRC connection can be configured for this APN. In one example, a decision on whether a connection to a specific APN can be established via the lightweight RRC connection or cannot be established by the lightweight RRC connection can be performed at the network. The network can perform the decision based on an agreement with third party service providers, or via monitoring of the applications and gathering statistics. Moreover, the network can continuously monitor the behavior of the applications, and change the configuration when the applications do not behave according to lightweight expectations.

In one example, lightweight RRC connections can be allowed based on the APN that is connected to by the UE. If an application requests the establishment of a connection towards a specific APN, then the UE can select the lightweight RRC connection. In another example, once the UE starts a connection towards a given APN, the UE can use the established bearer to transmit packets only from the application that triggered the lightweight RRC connection procedure. If a different application is started at the UE, the UE can start a legacy RRC connection procedure with a service request even if the different application is towards the same APN, which can thereby avoid abuse of the lightweight RRC connection procedure. In yet another example, once the UE starts a lightweight RRC connection towards a given UE, the UE can use the established bearer to transmit packets from any application towards the same APN. In a further example, the number of applications using the lightweight RRC connection towards the same APN at the same time can be limited, or a maximum number of bits/second can be pre-configured, or a specific duration or timer may be set.

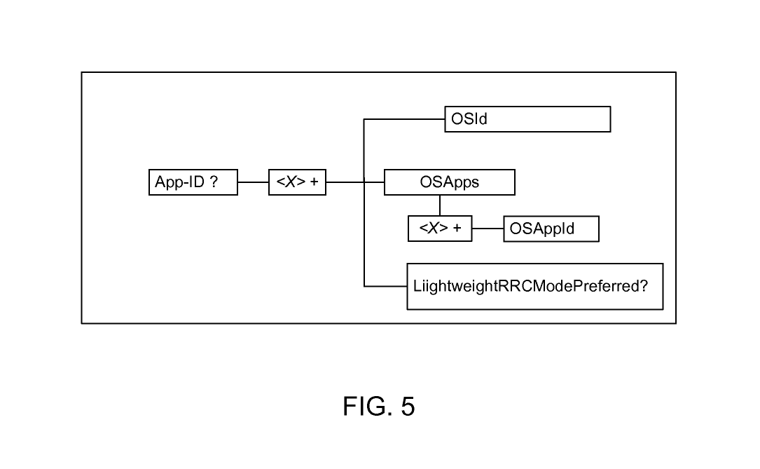

FIG. 5 illustrates an exemplary lightweight radio resource control (RRC) connection configuration for a user equipment (UE) on a per application basis. One or more applications can be configured for the lightweight RRC connection. If one of the configured applications is requesting the establishment of a connection, the UE can choose to establish the lightweight RRC connection. The network can configure the applications for the lightweight RRC connection using Open Mobile Alliance-Device Management (OMA-DM) functionality by sending information about the applications in an OMA-Management Object (OMA-MO) to the UE. Alternatively, the network can configure the applications for the lightweight RRC connection using Access Network Discovery and Selection Function (ANDSF) management objects (MO) that are sent to the UE.

In one example, once the UE starts a first application using the lightweight RRC connection, if a second application also configured for the lightweight RRC connection wishes to communicate, the UE can start the legacy RRC connection procedure in order to avoid abuse of the lightweight RRC connection procedure. In another example, once the UE starts one application using the lightweight RRC connection, the UE can use the established bearer to transmit packets from other applications configured for the lightweight RRC connection. In yet another example, the number of applications using the lightweight connection at the same time can be limited, or a maximum number of bits/second can be pre-configured, or a specific duration or timer may be set.

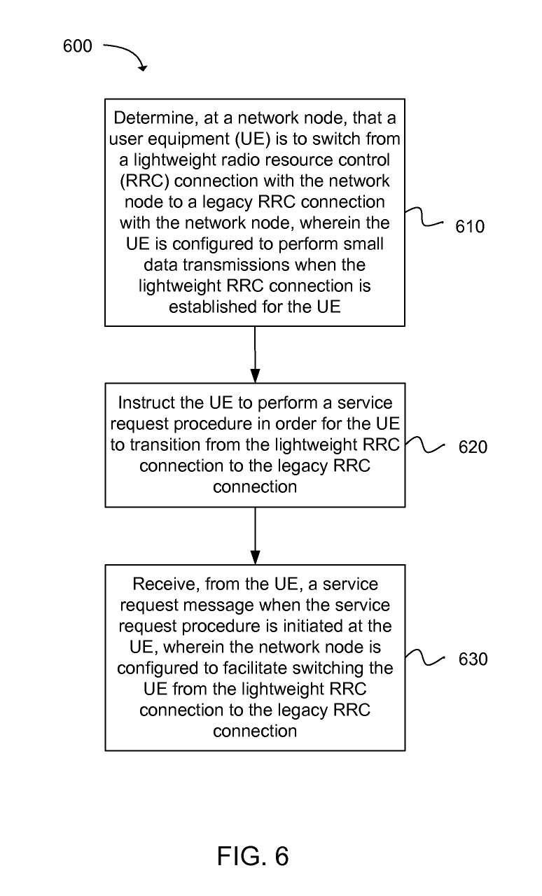

Another example provides functionality 600 of an apparatus of a network node, as shown in the flow chart in FIG. 6. The functionality can be implemented as a method or the functionality can be executed as instructions on a machine, where the instructions are included on at least one computer readable medium or one non-transitory machine readable storage medium. The apparatus can comprise circuitry configured to determine, at the network node, that a user equipment (UE) is to switch from a lightweight radio resource control (RRC) connection with the network node to a legacy RRC connection with the network node, wherein the UE is configured to perform small data transmissions when the lightweight RRC connection is established for the UE, as in block 610. The apparatus can comprise circuitry configured to instruct the UE to perform a service request procedure in order for the UE to transition from the lightweight RRC connection to the legacy RRC connection, as in block 620. The apparatus can comprise circuitry configured to receive, from the UE, a service request message when the service request procedure is initiated at the UE, wherein the network node is configured to facilitate switching the UE from the lightweight RRC connection to the legacy RRC connection, as in block 630.

In one example, the circuitry is configured to: monitor, at the network node, the small data transmissions for the UE; and determine that the UE is to switch from the lightweight RRC connection to the legacy RRC connection when the small data transmissions for the UE are above a defined threshold. In one example, the circuitry is configured to monitor the small data transmissions for the UE by monitoring a number of media access control (MAC) packet data units (PDUs) that are transmitted from the UE.

In one example, the UE is instructed to stop using the lightweight RRC connection and initiate the service request procedure via an RRC connection setup message or an RRC connection reconfiguration message sent from the network node to the UE, wherein the RRC connection setup message or the RRC connection reconfiguration message includes an information element (IE) indicating for the UE to switch from the lightweight RRC connection to the legacy RRC connection. In one example, the circuitry is configured to determine that the UE is to switch from the lightweight RRC connection to the legacy RRC connection when applications in a defined category are initialized at the UE. In one example, the circuitry is configured to determine that the UE is to choose from the lightweight RRC connection or the legacy RRC connection based on an estimated amount of time for the UE to transmit data from a transmission buffer of the UE.

In one example, the circuitry is configured to: receive, at the network node, a general packet radio service (GPRS) tunneling protocol (GTP)-C message from a serving gateway (SGW), the GTP-C message indicating that a level of small data maintained in a buffer at the SGW for the UE is greater than a defined threshold; and determine that the UE is to switch from the lightweight RRC connection to the legacy RRC connection based on the level of small data maintained in the buffer at the SGW for the UE.

In one example, the circuitry is configured to determine to switch the UE from the lightweight RRC connection to the legacy RRC connection when the UE continues to request resources for an uplink (UL) transmission after expiry of a small data activity timer maintained at the network node. In one example, the circuitry is configured to: receive, at the network node, a general packet radio service (GPRS) tunneling protocol (GTP)-C message from a serving gateway (SGW), the GTP-C message indicating that downlink data for the UE continues to be accumulated in an SGW buffer after expiry of a small data activity timer maintained at the SGW; and determine to switch the UE from the lightweight connection to the legacy RRC connection when the downlink data for the UE continues to be accumulated in the SGW buffer after expiry of the small data activity timer.

In one example, the UE is instructed to stop using the lightweight RRC connection and initiate the service request procedure via a media access control (MAC) control element (CE) sent from the network node to the UE. In one example, the MAC CE includes bearer identity (ID) information for the legacy RRC connection and updated radio configuration information.

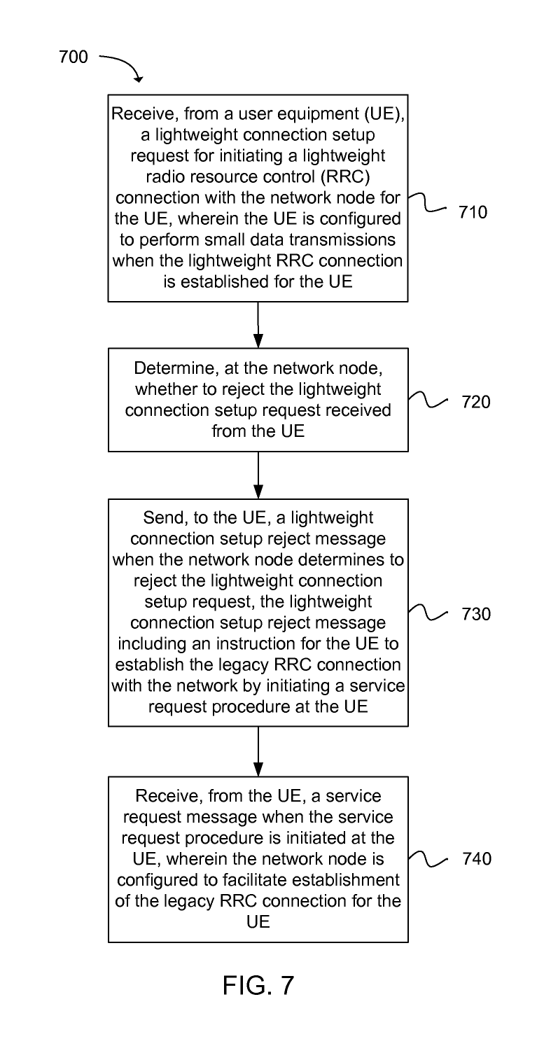

Another example provides functionality 700 of an apparatus of a network node, as shown in the flow chart in FIG. 7. The functionality can be implemented as a method or the functionality can be executed as instructions on a machine, where the instructions are included on at least one computer readable medium or one non-transitory machine readable storage medium. The apparatus can comprise one or more processors configured to receive, from a user equipment (UE), a lightweight connection setup request for initiating a lightweight radio resource control (RRC) connection with the network node for the UE, wherein the UE is configured to perform small data transmissions when the lightweight RRC connection is established for the UE, as in block 710. The apparatus can comprise one or more processors configured to determine, at the network node, whether to reject the lightweight connection setup request received from the UE, as in block 720. The apparatus can comprise one or more processors configured to send, to the UE, a lightweight connection setup reject message when the network node determines to reject the lightweight connection setup request, the lightweight connection setup reject message including an instruction for the UE to establish the legacy RRC connection with the network by initiating a service request procedure at the UE, as in block 730. The apparatus can comprise one or more processors configured to receive, from the UE, a service request message when the service request procedure is initiated at the UE, wherein the network node is configured to facilitate establishment of the legacy RRC connection for the UE, as in block 740.

In one example, the one or more processors are configured to determine to reject the lightweight connection setup request based on historical data transmissions by the UE. In one example, the one or more processors are further configured to configure a list of access point names (APNs) for which the UE is permitted to use the lightweight RRC connection, wherein the network node is configured to send the list of APNs in an Open Mobile Alliance-Management Object (OMA-MO) using OMA Device Management (OMA-DM) functionality. In one example, the one or more processors are further configured to configure a list of applications for which the UE is permitted to use the lightweight RRC connection, wherein the network node is configured to send the list of applications in an Open Mobile Alliance-Management Object (OMA-MO) using OMA Device Management (OMA-DM) functionality.

Another example provides functionality 800 of at least one non-transitory machine readable storage medium having instructions embodied thereon for switching a user equipment (UE) from a lightweight radio resource control (RRC) connection to a legacy RRC connection. The instructions, when executed, can cause a radio base station to perform determining, using at least one processor of a radio base station, that the UE is to switch from the lightweight RRC connection with the radio base station to the legacy RRC connection with the radio base station, wherein the UE is configured to perform small data transmissions when the lightweight RRC connection is established for the UE, as in block 810. The instructions, when executed, can cause the radio base station to perform instructing, using the at least one processor of the radio base station, the UE to perform a service request procedure in order for the UE to transition from the lightweight RRC connection to the legacy RRC connection, as in block 820. The instructions, when executed, can cause the radio base station to perform receiving, using the at least one processor of the radio base station, a service request message from the UE when the service request procedure is initiated at the UE, wherein the radio base station is configured to facilitate switching the UE from the lightweight RRC connection to the legacy RRC connection, as in block 830.

In one configuration, the at least one non-transitory machine readable storage medium can comprise instructions which when executed by the at least one processor of the radio base station performs the following: monitoring the small data transmissions for the UE; and determining that the UE is to switch from the lightweight RRC connection to the legacy RRC connection when the small data transmissions for the UE are above a defined threshold. In one configuration, the at least one non-transitory machine readable storage medium can comprise instructions which when executed by the at least one processor of the radio base station performs the following: determining to switch the UE from the lightweight RRC connection to the legacy RRC connection when the UE continues to request resources for an uplink (UL) transmission after expiry of a small data activity timer maintained at the network node.

In one configuration, the UE is instructed to stop using the lightweight RRC connection and initiate the service request procedure via a media access control (MAC) control element (CE) sent from the network node to the UE. In one configuration, the at least one non-transitory machine readable storage medium can comprise instructions which when executed by the at least one processor of the radio base station performs the following: configuring a list of applications for which the UE is permitted to use the lightweight RRC connection, wherein the radio base station is configured to send the list of applications in an Open Mobile Alliance-Management Object (OMA-MO) using OMA Device Management (OMA-DM) functionality.

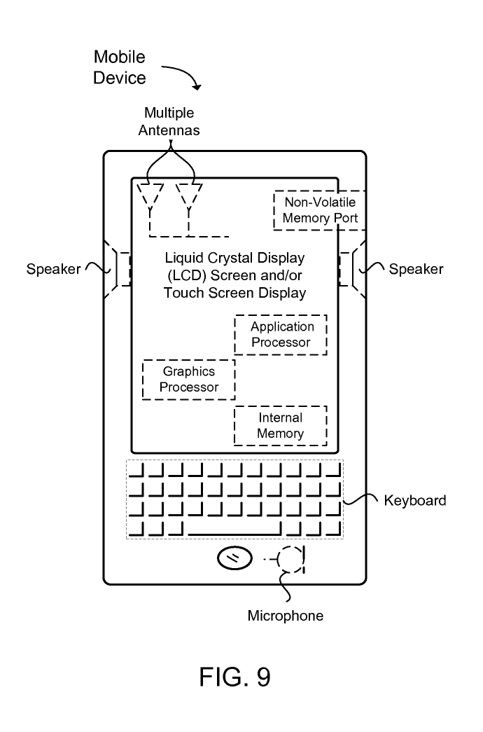

FIG. 9 provides an example illustration of the wireless device, such as a user equipment (UE), a mobile station (MS), a mobile wireless device, a mobile communication device, a tablet, a handset, or other type of wireless device. The wireless device can include one or more antennas configured to communicate with a node, macro node, low power node (LPN), or, transmission station, such as a base station (BS), an evolved Node B (eNB), a baseband unit (BBU), a remote radio head (RRH), a remote radio equipment (RRE), a relay station (RS), a radio equipment (RE), or other type of wireless wide area network (WWAN) access point. The wireless device can be configured to communicate using at least one wireless communication standard including 3GPP LTE, WiMAX, High Speed Packet Access (HSPA), Bluetooth, and WiFi. The wireless device can communicate using separate antennas for each wireless communication standard or shared antennas for multiple wireless communication standards. The wireless device can communicate in a wireless local area network (WLAN), a wireless personal area network (WPAN), and/or a WWAN.

FIG. 9 also provides an illustration of a microphone and one or more speakers that can be used for audio input and output from the wireless device. The display screen can be a liquid crystal display (LCD) screen, or other type of display screen such as an organic light emitting diode (OLED) display. The display screen can be configured as a touch screen. The touch screen can use capacitive, resistive, or another type of touch screen technology. An application processor and a graphics processor can be coupled to internal memory to provide processing and display capabilities. A non-volatile memory port can also be used to provide data input/output options to a user. The non-volatile memory port can also be used to expand the memory capabilities of the wireless device. A keyboard can be integrated with the wireless device or wirelessly connected to the wireless device to provide additional user input. A virtual keyboard can also be provided using the touch screen.

Various techniques, or certain aspects or portions thereof, can take the form of program code (i.e., instructions) embodied in tangible media, such as floppy diskettes, CD-ROMs, hard drives, non-transitory computer readable storage medium, or any other machine-readable storage medium wherein, when the program code is loaded into and executed by a machine, such as a computer, the machine becomes an apparatus for practicing the various techniques. Circuitry can include hardware, firmware, program code, executable code, computer instructions, and/or software. A non-transitory computer readable storage medium can be a computer readable storage medium that does not include signal. In the case of program code execution on programmable computers, the computing device can include a processor, a storage medium readable by the processor (including volatile and non-volatile memory and/or storage elements), at least one input device, and at least one output device. The volatile and non-volatile memory and/or storage elements can be a RAM, EPROM, flash drive, optical drive, magnetic hard drive, solid state drive, or other medium for storing electronic data. The node and wireless device can also include a transceiver module, a counter module, a processing module, and/or a clock module or timer module. One or more programs that can implement or utilize the various techniques described herein can use an application programming interface (API), reusable controls, and the like. Such programs can be implemented in a high level procedural or object oriented programming language to communicate with a computer system. However, the program(s) can be implemented in assembly or machine language, if desired. In any case, the language can be a compiled or interpreted language, and combined with hardware implementations.

As used herein, the term processor can include general purpose processors, specialized processors such as VLSI, FPGAs, or other types of specialized processors, as well as base band processors used in transceivers to send, receive, and process wireless communications.

It should be understood that many of the functional units described in this specification have been labeled as modules, in order to more particularly emphasize their implementation independence. For example, a module can be implemented as a hardware circuit comprising custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like.

In one example, multiple hardware circuits or multiple processors can be used to implement the functional units described in this specification. For example, a first hardware circuit or a first processor can be used to perform processing operations and a second hardware circuit or a second processor (e.g., a transceiver or a baseband processor) can be used to communicate with other entities. The first hardware circuit and the second hardware circuit can be integrated into a single hardware circuit, or alternatively, the first hardware circuit and the second hardware circuit can be separate hardware circuits.

Modules can also be implemented in software for execution by various types of processors. An identified module of executable code can, for instance, comprise one or more physical or logical blocks of computer instructions, which can, for instance, be organized as an object, procedure, or function. Nevertheless, the executables of an identified module need not be physically located together, but can comprise disparate instructions stored in different locations which, when joined logically together, comprise the module and achieve the stated purpose for the module.

Indeed, a module of executable code can be a single instruction, or many instructions, and can even be distributed over several different code segments, among different programs, and across several memory devices. Similarly, operational data can be identified and illustrated herein within modules, and can be embodied in any suitable form and organized within any suitable type of data structure. The operational data can be collected as a single data set, or can be distributed over different locations including over different storage devices, and can exist, at least partially, merely as electronic signals on a system or network. The modules can be passive or active, including agents operable to perform desired functions.

Reference throughout this specification to “an example” means that a particular feature, structure, or characteristic described in connection with the example is included in at least one embodiment of the present technology. Thus, appearances of the phrases “in an example” in various places throughout this specification are not necessarily all referring to the same embodiment.

As used herein, a plurality of items, structural elements, compositional elements, and/or materials can be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present technology can be referred to herein along with alternatives for the various components thereof. It is understood that such embodiments, examples, and alternatives are not to be construed as defacto equivalents of one another, but are to be considered as separate and autonomous representations of the present technology.

Furthermore, the described features, structures, or characteristics can be combined in any suitable manner in one or more embodiments. In the following description, numerous specific details are provided, such as examples of layouts, distances, network examples, etc., to provide a thorough understanding of embodiments of the technology. One skilled in the relevant art will recognize, however, that the technology can be practiced without one or more of the specific details, or with other methods, components, layouts, etc. In other instances, well-known structures, materials, or operations are not shown or described in detail to avoid obscuring aspects of the technology.

While the forgoing examples are illustrative of the principles of the present technology in one or more particular applications, it will be apparent to those of ordinary skill in the art that numerous modifications in form, usage and details of implementation can be made without the exercise of inventive faculty, and without departing from the principles and concepts of the technology. Accordingly, it is not intended that the technology be limited, except as by the claims set forth below.

What is claimed is:

1. An apparatus of a network node, the apparatus comprising circuitry configured to:
determine, at the network node, that a user equipment (UE) is to switch from a lightweight radio resource control (RRC) connection with the network node to a legacy RRC connection with the network node, wherein the UE is configured to perform small data transmissions when the lightweight RRC connection is established for the UE;
instruct the UE to perform a service request procedure in order for the UE to transition from the lightweight RRC connection to the legacy RRC connection; and
receive, from the UE, a service request message when the service request procedure is initiated at the UE, wherein the network node is configured to facilitate switching the UE from the lightweight RRC connection to the legacy RRC connection.

2. The apparatus of claim 1, wherein the circuitry is configured to:
monitor, at the network node, the small data transmissions for the UE; and
determine that the UE is to switch from the lightweight RRC connection to the legacy RRC connection when the small data transmissions for the UE are above a defined threshold.

3. The apparatus of claim 2, wherein the circuitry is configured to monitor the small data transmissions for the UE by monitoring a number of media access control (MAC) packet data units (PDUs) that are transmitted from the UE.

4. The apparatus of claim 1, wherein the circuitry is configured to instruct the UE to stop using the lightweight RRC connection and initiate the service request procedure via an RRC connection setup message or an RRC connection reconfiguration message sent from the network node to the UE, wherein the RRC connection setup message or the RRC connection reconfiguration message includes an information element (IE) indicating for the UE to switch from the lightweight RRC connection to the legacy RRC connection.

5. The apparatus of claim 1, wherein the circuitry is configured to determine that the UE is to switch from the lightweight RRC connection to the legacy RRC connection when applications in a defined category are initialized at the UE.

6. The apparatus of claim 1, wherein the circuitry is configured to determine that the UE is to choose from the lightweight RRC connection or the legacy RRC connection based on an estimated amount of time for the UE to transmit data from a transmission buffer of the UE.

7. The apparatus of claim 1, wherein the circuitry is configured to:
receive, at the network node, a general packet radio service (GPRS) tunneling protocol (GTP)-C message from a serving gateway (SGW), the GTP-C message indicating that a level of small data maintained in a buffer at the SGW for the UE is greater than a defined threshold; and
determine that the UE is to switch from the lightweight RRC connection to the legacy RRC connection based on the level of small data maintained in the buffer at the SGW for the UE.

8. The apparatus of claim 1, wherein the circuitry is configured to determine to switch the UE from the lightweight RRC connection to the legacy RRC connection when the UE continues to request resources for an uplink (UL) transmission after expiry of a small data activity timer maintained at the network node.

9. The apparatus of claim 1, wherein the circuitry is configured to:
receive, at the network node, a general packet radio service (GPRS) tunneling protocol (GTP)-C message from a serving gateway (SGW), the GTP-C message indicating that downlink data for the UE continues to be accumulated in an SGW buffer after expiry of a small data activity timer maintained at the SGW; and
determine to switch the UE from the lightweight connection to the legacy RRC connection when the downlink data for the UE continues to be accumulated in the SGW buffer after expiry of the small data activity timer.

10. The apparatus of claim 1, wherein the circuitry is configured to instruct the UE to stop using the lightweight RRC connection and initiate the service request procedure via a media access control (MAC) control element (CE) sent from the network node to the UE.

11. The apparatus of claim 10, wherein the MAC CE includes bearer identity (ID) information for the legacy RRC connection and updated radio configuration information.

12. An apparatus of a network node, the apparatus comprising one or more processors configured to:
receive, from a user equipment (UE), a lightweight connection setup request for initiating a lightweight radio resource control (RRC) connection with the network node for the UE, wherein the UE is configured to perform small data transmissions when the lightweight RRC connection is established for the UE;
determine, at the network node, whether to reject the lightweight connection setup request received from the UE;
send, to the UE, a lightweight connection setup reject message when the network node determines to reject the lightweight connection setup request, the lightweight connection setup reject message including an instruction for the UE to establish the legacy RRC connection with the network by initiating a service request procedure at the UE; and
receive, from the UE, a service request message when the service request procedure is initiated at the UE, wherein the network node is configured to facilitate establishment of the legacy RRC connection for the UE.

13. The apparatus of claim 12, wherein the one or more processors are configured to determine to reject the lightweight connection setup request based on historical data transmissions by the UE.

14. The apparatus of claim 12, wherein the one or more processors are further configured to configure a list of access point names (APNs) for which the UE is permitted to use the lightweight RRC connection, wherein the network node is configured to send the list of APNs in an Open Mobile Alliance-Management Object (OMA-MO) using OMA Device Management (OMA-DM) functionality.

15. The apparatus of claim 12, wherein the one or more processors are further configured to configure a list of applications for which the UE is permitted to use the lightweight RRC connection, wherein the network node is configured to send the list of applications in an Open Mobile Alliance-Management Object (OMA-MO) using OMA Device Management (OMA-DM) functionality.

16. At least one non-transitory machine readable storage medium having instructions embodied thereon for switching a user equipment (UE) from a lightweight radio resource control (RRC) connection to a legacy RRC connection, the instructions when executed cause a radio base station to perform the following:
determining, using at least one processor of a radio base station, that the UE is to switch from the lightweight RRC connection with the radio base station to the legacy RRC connection with the radio base station, wherein the UE is configured to perform small data transmissions when the lightweight RRC connection is established for the UE;
instructing, using the at least one processor of the radio base station, the UE to perform a service request procedure in order for the UE to transition from the lightweight RRC connection to the legacy RRC connection; and
receiving, using the at least one processor of the radio base station, a service request message from the UE when the service request procedure is initiated at the UE, wherein the radio base station is configured to facilitate switching the UE from the lightweight RRC connection to the legacy RRC connection.

17. The at least one non-transitory machine readable storage medium of claim 16, further comprising instructions which when executed by the at least one processor of the radio base station performs the following:
monitoring the small data transmissions for the UE; and
determining that the UE is to switch from the lightweight RRC connection to the legacy RRC connection when the small data transmissions for the UE are above a defined threshold.

18. The at least one non-transitory machine readable storage medium of claim 16, further comprising instructions which when executed by the at least one processor of the radio base station performs the following: determining to switch the UE from the lightweight RRC connection to the legacy RRC connection when the UE continues to request resources for an uplink (UL) transmission after expiry of a small data activity timer maintained at the network node.

19. The at least one non-transitory machine readable storage medium of claim 16, wherein the UE is instructed to stop using the lightweight RRC connection and initiate the service request procedure via a media access control (MAC) control element (CE) sent from the network node to the UE.

20. The at least one non-transitory machine readable storage medium of claim 16, further comprising instructions which when executed by the at least one processor of the radio base station performs the following: configuring a list of applications for which the UE is permitted to use the lightweight RRC connection, wherein the radio base station is configured to send the list of applications in an Open Mobile Alliance-Management Object (OMA-MO) using OMA Device Management (OMA-DM) functionality.
